(19) United States
(12) Patent Application Publication
(10) Pub. No.: US 2020/0046029 A1
(43) Pub. Date: Feb. 13, 2020

(54) Apparatus, System And Method For Generating An Aerosol

(71) Applicant: JT International S.A., Geneva (CH)

(72) Inventors: Kyle Adair, Lisburn (IE); Andrew Robert John Rogan, Forres (GB); Frederick Waldern, Zürich (CH); Daniel Wilhelm, Zürich (CH)

(73) Assignee: JT International S.A., Geneva (CH)

(21) Appl. No.: 16/499,043

(22) PCT Filed: Mar. 21, 2018
(86) PCT No.: PCT/EP2018/057083

§ 371 Date: Sep. 27, 2019

(30) Foreign Application Priority Data
Mar. 29, 2017 (EP) 17163608.7

(51) Int. Cl. A24F 47/00; F16K 31/02; G05B 15/02

(52) U.S. Cl. CPC A24F 47/008; G05B 15/02; F16K 31/02

(57) ABSTRACT

An apparatus for generating an aerosol and/or a vapour in an inhaler device includes a reservoir for storing a supply of a liquid; a heating system fluidly connected with the reservoir for receiving the liquid and configured to heat the liquid to generate the aerosol and/or vapor therefrom; a pumping system configured to pump the liquid from the reservoir to the heating system; and a valve arrangement for regulating flow from the pumping system to the heating system, the valve arrangement having at least one valve which is configured to transition from a closed position to an open position for transmitting the liquid from the pumping system to the heating system. An inhaler device includes the apparatus, and a system includes an inhaler device and a peripheral electronic device. A method of generating an aerosol and/or a vapor in an inhaler device is also provided.

### FIELD OF THE INVENTION

The present invention relates to an inhaler device, such as an electronic cigarette (e-cigarette), a personal vaporizer or an electronic vapor delivery system. More particularly, the invention relates to an apparatus for generating an aerosol and/or a vapor in such an inhaler device and a method for generating an aerosol or a vapor from a substance to be heated in such a device. The invention further relates to a system for generating an aerosol and/or a vapor from a liquid.

### BACKGROUND OF THE INVENTION

Inhaler devices of the above types, namely e-cigarettes and personal vaporizers and electronic vapor delivery systems, are proposed as an alternative to traditional smoking articles, such as cigarettes, cigarillos, cigars and the like. Typically, these inhaler devices are designed to heat a liquid solution or a gel to produce or generate an aerosol and/or a vapor to be inhaled by a user. This liquid or gel is usually a solution of propylene glycol (PG) and/or vegetable glycerine (VG), and typically contains a flavorant or one or more concentrated flavours.

Despite the increasing demand for these inhaler devices and the growing market, efforts are still required to develop the performance of these devices, with a view to offering more efficient and improved products. For example, these efforts are directed to improved aerosol and/or vapour generation, improved aerosol and/or vapor delivery, and a more efficient transport mechanism of the liquid or gel to be heated for the aerosol and/or vapor generation within the inhaler device.

At the same time, efforts are directed to making the experience of using the inhaler device as pleasant as possible for a user.

### SUMMARY OF THE INVENTION

In view of the above, an object of the invention is to provide a new and improved inhaler device, especially an electronic cigarette, and more particularly a new and improved apparatus, system and method for generating an aerosol and/or a vapor from a substance, such as a liquid.

In accordance with the invention, an apparatus as recited in claim 1 or claim 10, a system as recited in claim 13, and a method as recited in claim 15 or claim 16 are provided. Various advantageous and/or preferred features of the invention are recited in the dependent claims.

According to one aspect, therefore, the present invention provides an apparatus for generating an aerosol and/or a vapor in an inhaler device. The apparatus comprises: a reservoir, especially a volumetrically variable reservoir, for storing a supply of a liquid; a heating system fluidly connected with the reservoir which is configured to heat the liquid to generate the aerosol and/or vapor therefrom; a pumping system configured to pump the liquid from the reservoir to the heating system; and a valve arrangement having at least one valve which is configured to regulate the flow of liquid to the heating system. In particular, the at least one valve is configured to transition from a closed position to an open position for transmitting the liquid from the pumping system to the heating system.

In this way, the invention provides an apparatus in which the valve arrangement prevents leakage of the liquid to be heated from the reservoir, or from the pumping system, to the heating system. The leakage of liquid could otherwise become an irritant to a user of an inhaler device. Also, because pumps are generally bulkier than valves, the possible locations for a pumping system within the inhaler device are typically more limited than possible locations for valves. The positioning of the pumping system is further constrained by the need to minimize vibration during pumping which might cause acoustic and/or tactile irritation to a user of the inhaler device and/or undesirable heat generation. Thus, the use of a valve arrangement provides significantly more flexibility in the positioning of the pumping system in the apparatus of the invention.

In a preferred embodiment, the at least one valve is located between the pumping system and the heating system. In particular, the at least one valve is preferably arranged in the fluid connection between the pumping system and the heating system (i.e. arranged downstream of the pumping system and upstream of the heating system) for regulating the flow of liquid to the heating system.

In a preferred embodiment, the at least one valve is actuated to transition from the closed position to the open position concurrently with, or as a result of, pumping by the pumping system. In this way, the opening of the at least one valve is limited to the times in which it is actually desired that liquid is conveyed from the reservoir to the heating element, thereby minimizing or eliminating undesired liquid leakage.

In a preferred embodiment, the at least one valve is actuated to transition from the closed position to the open position under the fluid pressure generated by the pumping system. In this way, operation of the at least one valve depends directly upon operation of the pumping system and no electric circuitry is needed to control the valve. The pumping system is thus configured to generated a sufficient fluid pressure to activate the at least one valve, which may, for example, be formed or provided as a duckbill valve. In this way, a back-flow of the liquid to the reservoir may be prevented.

In a preferred embodiment, the at least one valve may be electrically actuated to transition from the closed position to the open position. In this way, a more precise operation of the valve may be achieved. For example, the at least one valve may be formed as a solenoid valve. In some embodiments, the pumping system and the at least one valve may be concurrently controlled between an operative and an inoperative state. In other words, the apparatus may be configured such that, in the operative state, the pumping system is pumping and the at least one valve is electrically actuated to the open position and, in the inoperative state, the pumping system is deactivated and not pumping and the at least one valve is in the closed position.

In a preferred embodiment, the reservoir comprises a flexible container or flexible enclosure for storing the supply of the liquid. In this way, the flexible container or enclosure may act to provide a volumetric variability of the reservoir. In particular, the flexible container or enclosure may comprise a flexible web or membrane, which may be provided in the form of a bag or pouch. The flexible container or enclosure, such as a bag or pouch, has the advantage that it may not require any internal pressure equalization as the liquid contained therein is depleted, as would otherwise be the case for many rigid containers. A flexible bag, such as a plastic bag or pouch, may also be provided as a closed or sealed system. When such a flexible container is used in the apparatus of the invention, the valve arrangement may operate to prevent the flexible container from re-expanding as the liquid is consumed or depleted. In this way, a depleted or spent reservoir may assume a compact configuration and may therefore be easier to remove from the apparatus.

In another embodiment, the reservoir comprises a rigid container or enclosure and may optionally include an equalization valve for pressure equalization as the liquid is pumped from the reservoir to the heating element.

In a preferred embodiment, the reservoir is fluidly connected with the heating system at least partially by means of a porous or absorbent member, which may thus convey or transmit the liquid from the reservoir by capillary action. The porous or absorbent member may comprise or consist of filaments, fibres, foam material, or some other open-celled porous member. In an embodiment, the reservoir may be fluidly connected with the heating system by means of one or more transfer members configured to convey or transmit the liquid from the reservoir by capillary action. In this way, the one or more transfer members may, for example, comprise capillary tubes or closely-spaced plate elements that define one or more capillary channels or slots for conveying or transmitting the liquid by capillary action.

In a preferred embodiment, the pumping system includes at least one micro-pump and is configured to convey the liquid from the reservoir to the heating system at a flow rate in the range of about 0.1 to 0.5 ml/min, more preferably in the range of about 0.1 to 0.2 ml/min. A micro-pump naturally has small dimensions providing a compact configuration of the apparatus, and is able to provide a stable and adjustable liquid feed which can be controlled via open or closed control loops. The at least one micro-pump may be selected from micro-pump designs and is preferably provided as a diaphragm pump, especially as a piezoelectric pump. Piezoelectric pumps provide a suitable flow rate of the pumped liquid and generate comparatively little noise and/or vibrations.

In a preferred embodiment, the reservoir is fluidly connected to the heating system via a plurality of conduits. In this regard, the reservoir may comprise a plurality of individual reservoir units or containers, with a respective one of the reservoir units is or containers being separately fluidly connected to the heating system by one of the plurality of conduits. The valve arrangement may thus comprise a plurality of valves, each valve being associated with a respective one of the plurality of conduits, and each valve being configured to transition from a closed position to an open position for transmitting the liquid to the heating system. Alternatively, one valve may regulate liquid flow through a plurality of conduits. By providing the fluid connection via a plurality of conduits, each conduit may have a smaller cross-section. In this way, each valve may also be formed with smaller dimensions. The smaller dimensioned conduits may also provide more design freedom, as smaller conduits may, for example, be arranged on paths along which a larger conduit could not be arranged.

In a preferred embodiment, the heating system includes an elongate heating element, especially an electrical resistance heating element. In the event that the fluid connection between the reservoir and the heating system is via a plurality of conduits, the conduits may be configured to deliver the liquid to the heating system at different positions along a longitudinal axis of the heating element. In this way, the liquid may be better distributed across the heating element and thus a more consistent or more efficient aerosol generation may result. Each said valve for the plurality of conduits may be arranged at a different position along the longitudinal axis of the elongate heating element. The elongate heating element is preferably provided as a filament or electrical resistor, and optionally has a serpentine, coiled, winding, or zig-zag shape.

In a preferred embodiment, the pumping system comprises a plurality of pumps. For example, in the event that the fluid connection between the reservoir and the heating system is via a plurality of conduits, each conduit may be associated with a respective one of the plurality of pumps. In this context, if a pump is associated with a conduit, the pump is configured to affect a flow of fluid through the conduit, e.g. by increasing or decreasing a pressure in the conduit or in a portion of the conduit. The pump may be arranged inside the conduit or between two portions of the conduit. If the pumping system comprises a plurality of pumps, greater control over the liquid transmitted from the reservoir to particular parts or sections of the heating system may be provided. In addition, instead of a single larger pump with larger dimensions, each of the plurality of pumps associated with a respective one of the conduits may be provided with smaller dimensions and may therefore be arranged more conveniently and more efficiently within the apparatus.

In a preferred embodiment, each pump of the pumping system is configured to operate in a cycle including a loading phase and a pumping phase. In the event that the pumping system comprises a plurality of pumps, the cycle of at least one of the pumps is configured to operate out-of-phase with the cycle of at least one other of the pumps. In this way, a more uniform overall transmission of liquid from the reservoir to the heating system may be achieved. Furthermore, audible and/or tactile emissions from the apparatus may be attenuated.

According to another aspect the invention provides an apparatus for generating an aerosol and/or vapor in an inhaler device, this apparatus comprising: a plurality of reservoirs, each of the reservoirs configured for storing a supply of a liquid; a heating system fluidly connected with the reservoirs and configured to heat the liquid to generate the aerosol and/or vapor therefrom; a pumping system which comprises a plurality of pumps, each pump being associated with a respective one of the reservoirs and being configured to convey the liquid to the heating system; and control circuitry for independently controlling the plurality of pumps.

By independently controlling the plurality of pumps, a composition of the liquid to be heated and, as a result, of the aerosol and/or vapor generated from the liquid, can be regulated or adjusted. Each of the plurality of reservoirs may be filled with one or more different liquids according to the preferences of a user.

In a preferred embodiment, the control circuitry is configured to receive control signals for independently controlling the plurality of pumps. In this way, a user may adjust the composition of the aerosol and/or vapor to be generated by providing the corresponding control signals.

In a preferred embodiment, the apparatus further comprises a user interface for providing the control signals to the control circuitry based upon a user inter-action with the user interface. The user interface is preferably integrated in a body of the apparatus and may comprise one or more buttons, a display and/or a touchscreen.

In a preferred embodiment, the apparatus further comprises a mixing device for mixing the liquid pumped from each of the reservoirs. In this way, a proper mixing or blending of individual liquids from each of the plurality of reservoirs can be achieved to provide a homogeneous aerosol and/or vapor. The mixing device is preferably located in the fluid connection between the pumping system and the heating system. The mixing device desirably includes at least one movable mixing member, such as an agitator. The movable mixing member may, for example, be electrically operated. Alternatively, or in addition, the mixing device may include one or more fixed mixing members, such as one or more baffles.

According to a further aspect, the present invention provides an inhaler device, such as a personal vaporizer or an e-cigarette, wherein the inhaler device includes an apparatus for generating an aerosol and/or vapor according to any one of the embodiments of the invention described above.

According to yet another aspect, the invention provides a system comprising: an inhaler device according to the invention as described above, and a peripheral electronic device configured to transmit control signals to the inhaler device, and especially to control circuitry of the inhaler device, in particular to control circuitry of the apparatus of the invention. In this way, a user of the inhaler device may use the peripheral electronic device to adjust generation of the aerosol and/or vapor in the inhaler device. The peripheral electronic device may, for example, comprise a smartphone, a smart watch, a tablet or a personal computer.

In a preferred embodiment, the system further comprises a remote resource, such as a remote server, wherein the peripheral electronic device is configured to receive instructions from the remote resource for generating the control signals for independently controlling the apparatus; e.g. for controlling the pumping system. A user may thus receive a pre-formulated recipe for a composition of the aerosol and/or vapor to be generated from the remote source. Conveniently, the peripheral electronic device may automatically, after a command input by the user, generate and transmit the control signals to the inhaler device for generating the aerosol and/or vapor according to the pre-formulated recipe.

According to a further aspect, the invention provides a method of generating an aerosol and/or a vapor in an inhaler device. The method comprises: providing a supply of a liquid, especially a volumetrically variable liquid supply; pumping the liquid from the supply to a heating system; actuating at least one valve of a valve arrangement connected between the liquid supply and the heating system to transmit the liquid to the heating system; and heating the liquid via the heating system to generate the aerosol and/or vapor from the liquid.

According to yet another aspect, the invention provides a method of generating an aerosol and/or vapor in an inhaler device, the method comprising: providing a plurality of reservoirs, each of the reservoirs configured for storing a supply of a liquid; providing a plurality of pumps, each pump being associated with a respective one of the plurality of reservoirs, for conveying liquid from the reservoirs to a heating system; independently controlling the plurality of pumps via one or more control signals; and heating the liquid via the heating system to generate the aerosol and/or vapor from the liquid.

In a preferred embodiment, the method further comprises receiving control signals for independently controlling the pumps from a peripheral electronic device. The method may optionally comprise the step of mixing the liquids from the plurality of reservoirs before the heating of the liquid, wherein the mixing preferably includes moving or displacing a mixing member of a mixing device.

### BRIEF DESCRIPTION OF THE DRAWINGS

For a more complete understanding of the invention and the advantages thereof, exemplary embodiments of the invention are explained in more detail in the following description with reference to the accompanying drawing figures, in which like reference characters designate like parts and in which:

FIG. 1 is a schematic view of an apparatus for generating an aerosol and/or vapour according to an embodiment of the invention;

FIG. 2 is a cross-sectional side view of an inhaler device according to an embodiment of the invention, wherein the inhaler device includes an apparatus for generating an aerosol and/or vapour according to a further embodiment of the invention;

FIG. 3 is a perspective, partially transparent view of the inhaler device and the apparatus shown in FIG. 2;

FIG. 4 is a perspective view of part of the apparatus for generating aerosol and/or vapour shown in FIG. 2 and FIG. 3;

FIG. 5 is a cross-sectional side view of the part of the apparatus shown in FIG. 4;

FIG. 6 is a flow diagram which schematically represents a method according to an embodiment of the invention; and

FIG. 7 is a schematic view of a system according to an embodiment of the invention, the system including an inhaler device with an apparatus for generating an aerosol and/or vapour according to an embodiment of the invention.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not actually required. It will also be understood that the terms and expressions used in the present specification have the ordinary meaning as is accorded to such terms and expressions with respect to their corresponding respective areas of inquiry and study, except where specific meanings have otherwise been set forth herein.

### DETAILED DESCRIPTION OF EMBODIMENTS

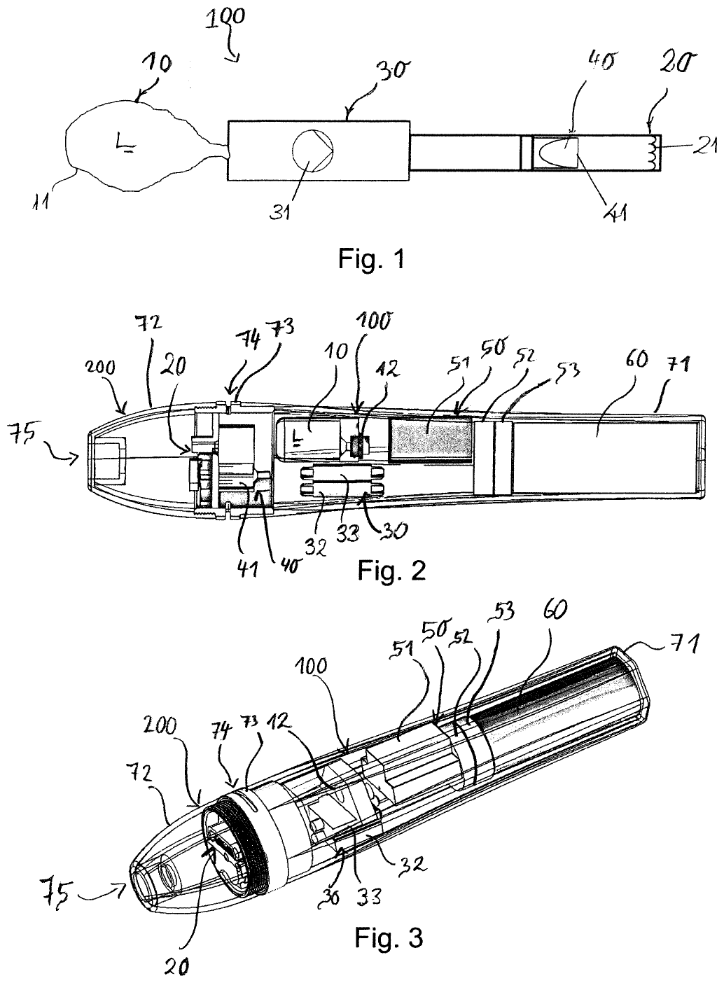

With reference to FIG. 1 of the drawings, one embodiment of an apparatus 100 for generating an aerosol and/or a vapor from a liquid L in an inhaler device, such as an e-cigarette (not shown), is illustrated schematically. The liquid may comprise a solution of glycol, vegetable glycerin, nicotine and/or one or more flavorants or flavor compounds.

The apparatus 100 comprises a reservoir 10 for storing a supply of liquid L to be heated. In this particular embodiment, the reservoir 10 is volumetrically variable and comprises a flexible container 11 for storing the supply of the liquid L. In this regard, the flexible container 11 comprises a flexible web or membrane that forms a bag or pouch. The reservoir 10 is integrated into the apparatus 100 and may be configured for refilling. Alternatively, the reservoir 10 may be disposable such that it can be inserted as a cartridge into the apparatus 100, and later removed from the apparatus 100 when the liquid L inside the reservoir 10 has been depleted.

The apparatus 100 further comprises a heating system 20 fluidly connected with the reservoir 10 for receiving the liquid and configured to heat and vaporize the liquid L to generate the aerosol and/or vapor therefrom. In this embodiment, the heating system 20 comprises at least one electrical resistance heating element 21, preferably in the form of a coil or filament.

The apparatus 100 also comprises a pumping system 30 having a pump 31 which is configured to pump or convey the liquid L from the reservoir 10 to the heating system 20. The pump 31 is preferably a micro-pump, and especially a diaphragm-type pump, such as a piezoelectric pump.

A valve arrangement 40 of the apparatus 100 is provided in the fluid connection between the pumping system 30 and the heating system 20 and is configured to regulate the flow of liquid L from the reservoir 10 to the heating system 20. In this regard, the valve arrangement 40 includes at least one valve 41 that is configured to transition from a closed position to an open position to transmit the liquid L from the pumping system 30 to the heating system 20. In the embodiment of FIG. 1, the valve 41 is configured as a duckbill valve which is fluidly actuated to transition to the open position by fluid pressure generated by the pumping system 30. It will be understood that other valve types may employed as an alternative to, or in addition to, a duckbill valve. For example, one or more electrically actuated valves may be used for the valve arrangement 40.

Referring to FIGS. 2 to 5 of the drawings, an embodiment of an inhaler device 200, especially an e-cigarette, comprising an apparatus 100 for generating an aerosol and/or vapor according to another embodiment, is illustrated schematically.

The apparatus 100 in the inhaler device 200 comprises a disposable reservoir 10 formed from a flexible container or bag 11 for storing a supply of a liquid L to be heated. The reservoir 10 is connectable in the apparatus 100 by means of a fluid port 12 such as a cartridge connector. The apparatus 100 furthermore comprises a heating system 20 for receiving the liquid L from the reservoir 10 and configured to heat and vaporize the liquid L to generate the aerosol and/or vapor therefrom. Via the fluid port 12, the reservoir 10 is fluidly connected to a pumping system 30 for delivering the liquid to the heating system 20. The pumping system 30 comprises a plurality of pumps 31; namely, a first pump 32 and a second pump 33. The first pump 32 and the second pump 33 are typically both formed as micro-pumps, more specifically, as piezoelectric pumps.

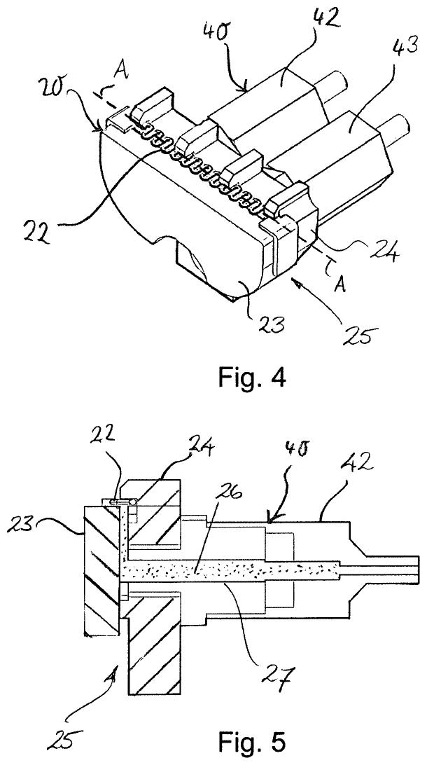

Also, the apparatus 100 comprises a valve arrangement 40 for regulating the flow of liquid L from the reservoir 10 via the pumping system 30 to the heating system 20. The valve arrangement 40 comprises a plurality of valves 41, especially check valves, specifically a first valve 42 and a second valve 43 (shown in FIG. 4). The first valve 42 and the second valve 43 are configured to transition from a closed position to an open position for transmitting the liquid from the pumping system 30 to the heating system 20. The valve arrangement 40 is fluidly arranged upstream of the heating system 20 and downstream of the pumping system 30. Desirably, the valve arrangement 40 is located directly adjacent, or proximate, to the heating system 20. In this way, the potential for fluid leakage to the heating system 20 due to remnants of fluid in the connection between the valve arrangement 40 and the heating system 20 can be minimized.

The heating system 20 is connected to the reservoir 10 via a plurality of conduits (not shown), e.g. by two conduits. In this way, each of the first valve 42 and the second valve 43 may be associated with a respective one of the two conduits. The first pump 32 and the second pump 33 may also be respectively associated with one of the two conduits. To this end, the apparatus 100 may comprise a manifold fluidly connected to the reservoir 10, wherein the plurality of pumps, i.e. the first pump 32 and the second pump 33 are each fluidly connected to the manifold member for pumping the liquid L from the reservoir 10 to the heating system 20. Alternatively, each of the plurality of pumps 32, 33 may be directly connected to the reservoir 10 by its respective associated conduit.

The apparatus 100 further comprises control circuitry 50 configured to control the first pump 32 and the second pump 33 for pumping the liquid from the reservoir 10 towards the heating system 20. Desirably, the control circuitry 50 is configured for independently controlling each of the pumps 32, 33.

With reference to FIG. 4 and FIG. 5 of the drawings, the heating system 20 and the valve arrangement 40 are shown in more detail. In the perspective view shown in FIG. 4, the heating system 20 can be seen to comprise a heating element 22 in the form of a resistance heating filament having a serpentine shape. When an electric current is conducted through the heating element 22, its temperature is increased by Ohmic heating and so that the liquid L transmitted or conveyed into contact with the heating element 22 is vaporized. The heating element 22 is arranged between a front side 23 and a rear side 24 of a heating system housing 25. Both the front side 23 and the rear side 24 of the housing 25 may comprise, or consist of, a ceramic material for thermally isolating the heating element 22 from other parts or elements of the apparatus 100 or the inhaler device 200; such as, for example, from the reservoir 10, the pumping system 30, and/or the control circuitry 50.

The heating element 22 is generally elongate and extends along a longitudinal axis A. Preferably, the plurality of conduits for delivering the liquid L to the heating system 20 are configured and arranged to deliver the liquid L to different positions along the longitudinal axis A of the heating element 22 so that the liquid may be distributed across the heating element 22 for more efficient aerosol generation. To this end, the two valves 42, 43 are located proximate to the heating system 20 at different positions along the longitudinal axis A of the heating element 22. As seen in the cross-section through the heating system 20 and valve arrangement 40 in is FIG. 5, the valve arrangement 40 is fluidly connected to the heating system 20 by an porous member 26 arranged in a conduit portion 27 for transmitting the liquid by capillary action.

With reference again to drawing FIGS. 2 and 3, other features of the apparatus 100 and the inhaler device 200 will now be briefly described. The control circuitry 50 may comprise a first printed circuit board assembly (PCBA) 51 with a micro-pump controller and/or a receiving circuit for receiving control signals for controlling the plurality of pumps based on the control signals. The micro-pump controller may be configured to provide actuation signals to the pumping system 30 in order to define a liquid feed rate by setting operating parameters of the pumping system 30.

The inhaler device 200 comprises a switch member, such as a push button (not shown), which is electrically connected to a second printed circuit board assembly (PCBA) 52 of the control circuitry 50. The switch member and control circuitry 50 are configured such that, upon actuating of the switch member, i.e. pressing of the push button, the pumping system 30 and heating system 20 are activated. In some embodiments, the valve arrangement 40 may comprise at least one electrically actuated valve 41. In that case, the control circuitry 50 may be configured such that upon actuating the switch member, the valve is also electrically actuated.

The heating system 20 and the pumping system 30, and possibly also the valve arrangement 40, are either activated simultaneously upon actuation of the switch member, or with a pre-set time delay with respect to one another, in view of the fact that the liquid must travel the distances between the pumping system 30 and the valve arrangement 40 and/or the heating system 20.

The inhaler device 200 further includes a power supply 60, such as a battery, for electrically powering the heating system 20, the pumping system 30, and possibly also the valve arrangement 40 in the event that one or more of the valves 42, 43 is electrically actuated. The control circuitry 50 may comprise a third printed circuit board assembly (PCBA) 53, including a power interface configured for connecting an external power source for recharging the power supply 60. The power interface may, for example, be formed as a micro USB connector. The third PCBA 53 may have approximately the same dimensions as the second PCBA 52.

The inhaler device 200 includes a generally hollow cylindrical casing 71, a mouthpiece 72, and an intermediate hub portion 73 which interconnects the casing 71 and the mouthpiece 72. In this regard, the mouthpiece 72 is attached to the hub portion 73 via a screw thread, as seen in FIG. 2. The casing 71 houses or encloses the apparatus 100 and the power supply 60. The hub portion 73 provides an air inlet 74 which is configured to permit an airflow to enter the inhaler device 200 and to pass via the heating element 22 of the heating system 20 into and through a central channel 75 of the mouthpiece 72 to a user of the inhaler device 200. In this way, a user may draw on the mouthpiece 72 and thereby inhale air via the inlet 74 such that the airflow becomes enriched or saturated with the aerosol and/or vapor generated at the heating element 22 on its way to the mouthpiece 72.

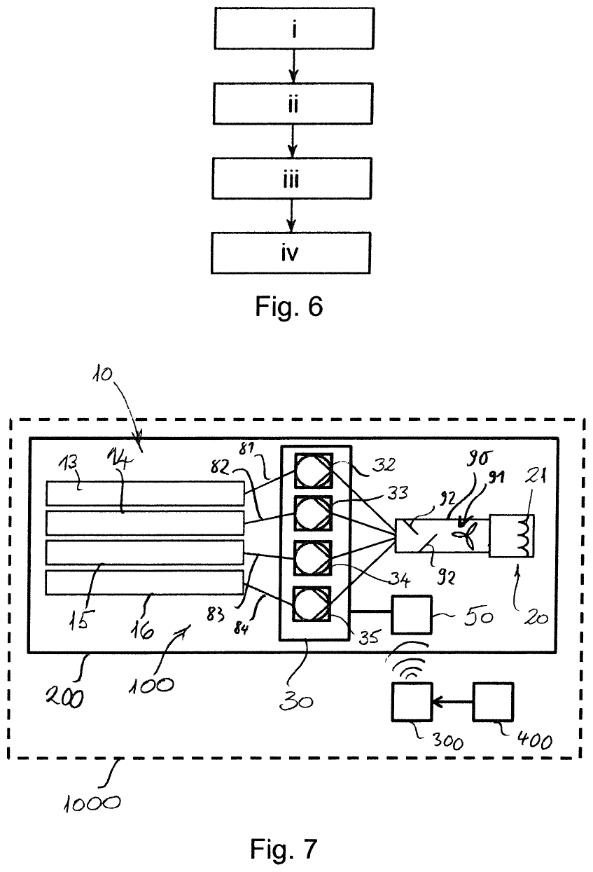

Referring now to FIG. 6 of the drawings, a flow diagram is shown that illustrates schematically the steps in a method of generating an aerosol and/or a vapor in an inhaler device 200, such as an e-cigarette, according to any of the embodiments of the invention described above with respect to FIGS. 1 to 5. In this regard, the box i of FIG. 6 represents the step of providing a supply of a liquid L to be vaporized, especially by providing a reservoir 10, such as a flexible bag 11. The second box ii then represents the step of pumping the liquid L from the supply 10 to a heating system 20, especially via a pumping system 30. The third box iii represents the step of actuating at least one valve 41-43 of a valve arrangement 40 connected between the liquid supply 10 and the heating system 20, especially between the pumping system 30 and the heating system 20, to transmit the liquid to the heating system 20. The final box iv in FIG. 6 of the drawings then represents the step of heating the liquid L via the heating system 20 to generate the aerosol and/or vapor from the liquid.

With reference to drawing FIG. 7, another embodiment of an inhaler device 200 having an apparatus 100 for generating an aerosol and/or a vapor is illustrated schematically. It will be noted that the elements and features of the apparatus 100 and/or the inhaler device 200 not specifically described with respect to FIG. 7 may be provided and configured as described above with respect to FIGS. 1 to 5. Also, FIG. 7 of the drawings schematically illustrates a system 1000 according to another aspect of the invention. The system 1000 includes the inhaler device 200 having the apparatus 100, as well as a peripheral electronic device 300 in conjunction with a remote source 400.

The apparatus 100 for generating an aerosol and/or a vapor in the system 1000 of FIG. 7 includes a plurality of reservoirs 13, 14, 15, 16, each of which is configured for storing a supply of a liquid L. The individual reservoirs 13, 14, 15, 16 may be configured in a similar way as described for the reservoir 10 above. That is, each of the reservoirs 13-16 may be a volumetrically variable reservoir in the form of a flexible bag or pouch 11. In this embodiment, the reservoirs 13-16 are typically filled with different liquids. For example, the first reservoir 13 may contain a base substance, such as propylene glycol (PG). The second reservoir 14 may contain a flavorant. The third reservoir 15 may contain an active substance, like nicotine, and the fourth reservoir 16 may contain vegetable glycerine (VG).

In this embodiment the apparatus 100 again includes a heating system 20 in fluid connection with the reservoirs 13-16 for receiving the liquid(s) from the reservoirs and configured to heat the liquid(s) to generate the aerosol and/or vapor therefrom. Each of the reservoirs 13-16 is associated, and fluidly connected, with a respective conduit 81, 82, 83, 84 of a plurality of conduits for transmitting the liquid from the respective reservoir 13, 14, 15, 16 to the heating system 20. Associated with each of the conduits 81-84 is a respective pump 32, 33, 34, 35 of a plurality of pumps which are part of a pumping system 30. The individual pumps 32-35 may be configured as described in the foregoing, particularly as described with respect to the first and the second pump 32, 33 in FIGS. 2-5. That is, the individual pumps 32-35 are typically configured as micro-pumps, specifically as piezoelectric pumps. Again, the apparatus 100 has control circuitry 50 for independently controlling the plurality of pumps 32-35, which may be configured essentially as described with respect to FIGS. 1 to 5.

A mixing device 90 for mixing the liquid L pumped from the plurality of reservoirs 13-16 is fluidly connected to the heating system 20. That is, the mixing device 90 is arranged between the pumping system 30 and the heating system 20 and all of the conduits 81-84 feed into the mixing device 90 so that none of the liquids stored in the reservoirs 13-16 are transmitted or conveyed to the heating system 20 without having first passed the mixing device 90. The mixing device 90 comprises an electrically actuated mixing member 91, such as a rotary agitator or mixing head, which may be operated or controlled by the control circuitry 50. Preferably, the control circuitry 50 is configured to activate the mixing member 91 essentially simultaneously with, or after a pre-set time delay following, actuation of a switch member (not shown) as described with reference to FIG. 2 and FIG. 3. The mixing device 90 may further, or as an alternative to the movable mixing member 91, comprise one or more fixed mixing members 92, such as baffles.

By controlling the plurality of pumps 32-35 individually via the control circuitry 50, and by mixing the fluids via the mixing device 90, an individual blend of liquids can be selected and, correspondingly therefore, an individual blend of the generated aerosol and/or vapour may be created or selected by a user. The control circuitry 50 is configured to receive control signals for independently controlling the plurality of pumps 32-35. The control signals may be received via a user interface arranged at the inhaler device 200, wherein the user interface is configured to generate the control signals based on a user interaction with the user interface. In this regard, the control signals are desirably received from the peripheral electronic device 300 at a receiver of the control circuitry 50 in the inhaler device 200. These control signals may be transmitted from the peripheral electronic device 300 to the inhaler device 200 over any known wireless, or even wire-bound, communication protocol, such as WiFi, Bluetooth, Ethernet, ZigBee and so on.

The peripheral electronic device 300 is preferably a smartphone, a smart watch or a tablet PC. The peripheral electronic device 300 may run an application which provides a graphical user interface to a user, allowing the user to adjust the control signals and thereby allowing him/her to adjust a composition of the aerosol and/or vapor to be generated. For example, scroll bars, each representing one liquid, may be shown by the graphical user interface.

The peripheral electronic device 300 may be configured to receive instructions from a remote source 400 such as a server, for generating the control signals. For example, a recipe for a certain composition of the aerosol and/or vapor to be generated may be received from remote source 400 at the peripheral electronic device 300. The peripheral electronic device 300 may then automatically generate the control signals based on the received instructions, i.e. based on the recipe, and transmit them to the control circuitry 50. The control circuitry 50 may translate the control signals received from the peripheral electronic device 300 into the respective actuation signals for the individual pumps 32-35 and actuate the pumps using the actuation signals.

Referring again to the flow diagram in FIG. 6 of the drawings, said flow diagram may also illustrate schematically the steps in a method of generating an aerosol and/or a vapor in an inhaler device, such as an e-cigarette, according to the embodiment of the invention described above with respect to FIG. 7 In this regard, the box i of FIG. 6 then represents the step of providing a plurality of reservoirs 13-16, each of which is configured for storing a supply of a liquid. The next box ii of FIG. 6 would then represents the step of providing a plurality of pumps 32-35, each pump 32-35 being associated with a respective one of the plurality of reservoirs for conveying liquid from the reservoirs 13-16 to a heating system 20. The box iii of FIG. 6 then represents the step of independently controlling the plurality of pumps 32-35 via one or more control signals. Optionally, the method may comprise a step of receiving the control signals for independently controlling the pumps 32-35 from a peripheral electronic device 300. The method may also include the optional step of mixing the liquids from the plurality of reservoirs 13-16 before the heating of the liquid, wherein the mixing may include moving or displacing a mixing member 91 of a mixing device 90. Finally, the box iv of FIG. 7 represents the step of heating the liquid, preferably the mixed liquid, via the heating system 20 to generate the aerosol and/or vapor from the liquid.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first”, “second”, “third”, etc. are used merely as labels, and are not intended to impose numerical requirements on or to establish a certain ranking of importance of their objects.

### LIST OF DRAWING SIGNS

10 reservoir
11 flexible container or bag
12 fluid port
13 first reservoir
14 second reservoir
15 third reservoir
16 fourth reservoir
20 heating system
21 heating element
22 heating element
23 front side
24 rear side
25 housing
26 porous member
27 conduit portion
30 pumping system
31 pump
32 first pump
32 second pump
33 third pump
34 fourth pump
35 valve arrangement
41 valve
42 first valve
43 second valve
50 control circuitry
51 first printed circuit board assembly
52 second printed circuit board assembly
53 third printed circuit board assembly
60 power supply
71 first casing
72 second casing
73 hub portion
74 air inlet
75 mouthpiece interface
81 conduit
82 conduit
83 conduit
84 conduit
90 mixing device
91 mixing member
92 baffles
100 apparatus
200 inhaler device
300 peripheral electronic device
400 remote source
1000 system
L liquid
A axis

1. An apparatus for generating an aerosol and/or a vapor in an inhaler device, the apparatus comprising:
a reservoir for storing a supply of a liquid;
a heating system fluidly connected with the reservoir for receiving the liquid and configured to heat the liquid to generate the aerosol and/or the vapor therefrom;
a pumping system configured to pump the liquid from the reservoir to the heating system; and
a valve arrangement for regulating flow from the pumping system to the heating system, the valve arrangement having at least one valve which is configured to transition from a closed position to an open position for transmitting the liquid from the pumping system to the heating system.

2. The apparatus according to claim 1, wherein the at least one valve is located or operatively arranged between or interconnecting the pumping system and the heating system.

3. The apparatus according to claim 1, wherein the at least one valve is actuated to transition from the closed position to the open position under fluid pressure generated by the pumping system.

4. The apparatus according to claim 1, wherein the at least one valve is electrically actuated to transition from the closed to the open position.

5. The apparatus according to claim 1, wherein the heating system is at least partially fluidly connected with the reservoir via a porous member.

6. The apparatus according to claim 1, wherein the pumping system comprises a pump configured to convey the liquid from the reservoir to the heating system at a flow rate in the range of 0.1 ml/min to 0.2 ml/min.

7. The apparatus according to claim 1, wherein the heating system is fluidly connected with the reservoir via a plurality of conduits, wherein the at least one valve comprises a plurality of valves, each of the valves being associated with a respective one of the conduits and being configured to transition from a closed position to an open position for transmitting the liquid to the heating system.

8. The apparatus according to claim 7, wherein the heating system includes an elongate heating element, wherein the plurality of conduits are arranged to deliver the liquid to the heating system at different positions along a longitudinal axis of the heating element.

9. The apparatus according to claim 7, wherein the pumping system comprises a plurality of pumps, wherein each conduit is associated with a respective one of the plurality of pumps; each of the pumps preferably being configured to operate in a cycle comprising a loading phase and a pumping phase, wherein the cycle of at least one of the pumps is configured to operate out-of-phase with the cycle of at least another one of the pumps.

10. An apparatus for generating an aerosol and/or a vapor in an inhaler device, the apparatus comprising:
a plurality of reservoirs, each of the reservoirs configured for storing a supply of a liquid;
a heating system fluidly connected with the reservoirs and configured to heat the liquid from the reservoirs to generate the aerosol and/or the vapor therefrom;
a pumping system comprising a plurality of pumps, each pump being associated with a respective one of the reservoirs and being configured to convey the liquid to the heating system;
a mixing device for mixing the liquid pumped from the plurality of reservoirs, the mixing device being located between the plurality of pumps and the heating system; and
control circuitry for independently controlling the plurality of pumps, the control circuitry being adapted or configured to receive control signals input by a user for independently controlling the plurality of pumps.

11. The apparatus according to claim 10, further comprising a user interface for providing the control signals to the control circuitry based on a user interaction with the user interface.

12. An inhaler device, such as a personal vaporizer or e-cigarette, comprising the apparatus for generating an aerosol and/or a vapor from a liquid according to claim 1.

13. A system for generating an aerosol and/or a vapor from a liquid, the system comprising:
the inhaler device according to claim 12, and
a peripheral electronic device configured to transmit control signals to the inhaler device.

14. The system according to claim 13, further comprising a remote source, wherein the peripheral electronic device is configured to receive instructions from the remote source for generating control signals for independently controlling a plurality of pumps of the pumping system.

15. A method of generating an aerosol and/or a vapor in an inhaler device, the method comprising:
providing a supply of a liquid;
pumping the liquid from the supply to a heating system;
actuating at least one valve of a valve arrangement connected between the liquid supply and the heating system to transmit the liquid to the heating system; and
heating the liquid via the heating system to generate the aerosol and/or the vapor from the liquid.

16. A method of generating an aerosol and/or a vapor in an inhaler device, the method comprising:
providing a plurality of reservoirs, each of the reservoirs configured for storing a supply of a liquid;
providing a plurality of pumps, each pump being associated with a respective one of the plurality of reservoirs, for conveying liquid from the reservoirs to a heating system;
independently controlling the plurality of pumps via control signals received from a peripheral electronic device;
mixing the liquid conveyed from the plurality of reservoirs; and
heating the mixed liquid via the heating system to generate the aerosol and/or the vapor from the liquid.

17. The apparatus according to claim 1, wherein the reservoir is a volumetrically variable reservoir.

18. The apparatus according to claim 1, wherein the at least one valve is fluidly connected to the heating system by a porous member.

19. The apparatus according to claim 10, wherein the mixing device includes at least one agitator.

20. The system according to claim 14, wherein the remote source is a remote server.
